(19) United States
(12) Patent Application Publication
(10) Pub. No.: US 2008/0017704 A1
(43) Pub. Date: Jan. 24, 2008

(54) Contactless Electronic Wallet Payment Device

(75) Inventors: Theodore VanDeburg, Denver, CO (US); Sarah Owen, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/672,417

(22) Filed: Feb. 7, 2007

Related U.S. Application Data
(60) Provisional application No. 60/833,022, filed on Jul. 24, 2006.

(51) Int. Cl. G06K 5/00

(52) U.S. Cl. 235/380

(57) ABSTRACT

A contactless electronic wallet is disclosed. The contactless electronic wallet may include a communications interface adapted to receive financial account information from a computer. The contactless electronic wallet may also include a memory device adapted to electronically store financial account information for at least one financial account. The contactless electronic wallet may further include a user interface adapted to communicate an account list to a user comprising at least one financial account associated with financial account information stored in the memory device, wherein the user selects a first financial account from the account list. The contactless electronic wallet may include a RF antenna that communicates account information associated with the first account to a radio frequency-enabled communication device. And, the contactless electronic wallet may include a processor coupled with the communications interface, the memory device, the user interface, and the RF antenna.

### CROSS-REFERENCES TO RELATED APPLICATIONS

This application claims the benefit, and is a non-provisional application, of U.S. Provisional Application No. 60/833,022, filed on Jul. 24, 2006, which is hereby expressly incorporated by reference in its entirety for all purposes.

### BACKGROUND OF THE INVENTION

This disclosure relates in general to a contactless electronic wallet and, but not by way of limitation, to a contactless electronic wallet that stores account information for one or more financial accounts downloaded from a webpage amongst other things.

Today merchants and service providers accept many forms of payment. Many merchants accept cash, credit cards, debit cards, contactless payment devices, loyalty program cards, stored-value cards, checks, and promotional items such as coupons. Some of these forms of payment must often be carried by a consumer because some merchants and/or service providers may only accept some of the various possible forms of payment. Sometimes a customer may not pre-plan a visit to a specific merchant and/or service provider, so the consumer may wish to carry the different forms of payment in case the consumer does happen to make an unplanned visit.

This can lead to a consumer carrying a number of payment methods or devices on a day-to-day basis. Additionally, a consumer may also need to carry other items regularly such as drivers license, identification cards, loyalty program cards, and membership cards. When a consumer has to carry all of these items, the items may become disorganized and/or misplaced, causing security concerns, and possibly causing transactions to consume more time. Furthermore, accumulations of credit cards, payment fobs, and debit cards can become quite bulky and burdensome. Embodiments of the present invention provide solutions to these and other concerns.

### BRIEF SUMMARY OF THE INVENTION

In one embodiment, the present disclosure provides a contactless electronic wallet that may include a communications interface, a memory device, a user interface, a RF antenna and a processor. The communications interface is adapted to receive financial account information related to at least one financial account from a computer that is received at the computer through the Internet. The memory device is adapted to electronically store financial account information for at least one financial account received through the communications interface from the computer. The user interface is adapted to communicate to a user an account list that includes at least one financial account associated with financial account information stored in the memory device and adapted to let the user select a first financial account from the account list. The RF antenna communicates account information associated with the first account to a radio frequency-enabled communication device. The processor is coupled with the communications interface, the memory device, the user interface, and the RF antenna. The contactless electronic wallet may also include a key chain and/or a USB connector. The contactless electronic wallet may also include a switch, such as a mechanical switch, a biometric switch, and a heat-sensitive switch.

In other embodiments the contactless electronic wallet may include financial account information that is received at a computer from a one or more financial institution web servers through the internet. The user interface may include a touch screen, a display, and/or at least one button. The computer interface may communicate wirelessly with the computer. The computer interface may communicate with the computer using a communications standard such as Bluetooth, radio frequency, Wi-Fi, USB, mini USB, and/or FireWire. The financial account information may include information selected from the group consisting of account number, account provider name, available credit, and available stored value. The financial account information may be downloaded by the user from a webpage. The financial account in the account list may be displayed on screen as a graphical icon.

In another embodiment the disclosure provides for a method for managing account information at a contactless electronic wallet. The method may include receiving financial account information related to at least one financial account from a computer that was received at the computer through the Internet. The method may include storing the financial account information received from the computer through the communications interface in a memory device. Also, the method may include communicating to a user a financial account list comprising at least one financial account associated with the financial account information stored in the memory device. The method may further include receiving a first selection from the user, wherein the first selection comprises a first financial account selected by the user from the account list. And, the method may include communicating the financial account information associated with the first account to a radio frequency-enabled communication device. In other embodiments the method for managing account information may include presenting an icon representing an account on a display.

In yet another embodiment, the present disclosure provides for an account management system for managing accounts on a contactless electronic wallet. The account management system may include a network interface connected to the Internet and in communication with an account provider; a memory device adapted to store account information received through the network interface; a contactless electronic wallet interface that may be connected to a contactless electronic wallet; and a processor. The processor may include instructions to receive a plurality of account information for a plurality of accounts from a plurality of account providers over the internet. The processor may also include instructions to store the plurality of account information in the memory device. The processor may further include instructions to transmit at lease one of the plurality of account information to a contactless electronic wallet through the contactless electronic wallet interface. The processor may also include instructions to automatically transmit account information when a contactless electronic wallet is connected to the account management system. The processor may also include instructions to reformat account information prior to transmitting the account information to the contactless electronic wallet.

In another embodiment of the account management system the contactless electronic wallet interface communicates with the contactless electronic wallet using Bluetooth, radio frequency, Wi-Fi, USB, mini USB, and/or FireWire standards. The account management system downloads account information form a webpage. And, the account information may include account number, account provider name, available credit, and available stored value.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 shows a contactless electronic wallet according to one embodiment of the invention.

FIG. 2A shows a contactless electronic wallet in communication with a computer according to one embodiment of the invention.

FIG. 2B shows a contactless electronic wallet wirelessly in communication with a computer according to one embodiment of the invention.

FIG. 2C shows a contactless electronic wallet wirelessly in communication with a computer that is in communication with multiple web servers according to one embodiment of the invention.

FIG. 2D shows two contactless electronic wallets wirelessly in communication with two computers that is in communication with multiple web servers according to one embodiment of the invention.

FIG. 3 shows a screen shot of a contactless electronic wallet according to one embodiment of the invention.

FIG. 4 shows a flowchart describing a method of using a contactless electronic wallet according to one embodiment of the invention.

FIG. 5 shows a flowchart describing a method of using a contactless electronic wallet according to one embodiment of the invention.

FIG. 6 shows a block diagram of a contactless electronic wallet according to one embodiment of the invention.

FIG. 7 shows a contactless electronic wallet with a USB connector according to one embodiment of the invention.

FIG. 8 shows a contactless electronic wallet in communication with a radio frequency-enabled communication device according to one embodiment of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The following description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

A simple contactless electronic wallet is disclosed. The device, in one embodiment of the invention, may be used solely for storing one or more financial accounts and transferring account information to a radio frequency point of sale device. The contactless electronic wallet may be unencumbered by a combination of features unrelated to electronic transactions and/or payments. The contactless electronic wallet may also receive account information from a computer.

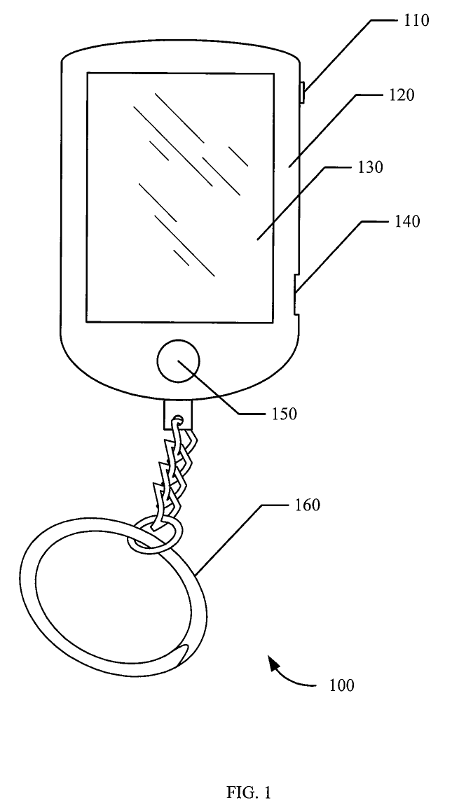

Referring first to FIG. 1, a contactless electronic wallet 100 is shown according to one embodiment of the invention. The contactless electronic wallet 100 includes a switch 110, an outer casing 120, a display 130, a communication interface 140, a button 150 or buttons, and a key chain 160. Other embodiments of the invention may not include every feature shown in this embodiment of the invention. For example, a contactless electronic wallet 100 may not include the key chain 160, button 150, communication port 140, display 130, or switch 110.

The contactless electronic wallet 100 may enclose circuitry within the outer casing 120. For example, the contactless electronic wallet may include a battery, RFID chip or chips, an antenna, memory, a processor, a video chip, RFID chip, a display controller, a speaker, etc. The outer casing 120 is sized to fit comfortably within a users hand and is easily stored in a user's purse, bag or pocket. The outer casing may comprise molded plastic.

The display 130 is part of a contactless electronic wallet user interface. The display 130 presents information to the user. The display 130 may present one or more accounts to the user. For example, the display may be an LCD display.

The display 130 may also be a touch display according to one embodiment of the invention. Accordingly, the display not only presents information to a user, but also receives information from the user. The display 130 may present one or more icons, each representing a stored financial account. The user may select a financial account by touching an icon on the touch display. The financial account may be communicated to a radio frequency-enabled terminal to complete a financial transaction. The display 130 may also ask the user to enter a pass code or PIN prior to accessing payment information.

The switch 110 may be included in embodiments of a contactless electronic wallet 100. The switch 1 10 may prevent fraudulent activity by a sniffing device. A radio frequency-enabled communication device with enough power or within close enough proximity to the contactless electronic wallet 100 may read account information from the contactless electronic wallet for fraudulent uses. To protect the account information from such fraudulent activity, the switch 110 prevents communication with a radio frequency-enabled communication device unless the switch 110 is switched to the “ON” position. If the switch is in the “OFF” position, the contactless electronic wallet is incapable of communicating account or other information. Other types of switches may be used, for example, a heat-activated switch, a biometric switch, a variety of mechanical switches, etc. The switch 110 may be placed anywhere on the outer casing 120. The switch may also be used to turn the touch display “ON” and “OFF”, according to one embodiment of the invention.

The contactless electronic wallet 100 may also include a button 150, a series of buttons, and/or a click wheel. A button 150 or buttons may be included on the outer casing for input from the user. For example, the user may use the button 150 or buttons to select an account from one or more payment options presented on the display 130. In another embodiment, the button may change settings on the display, for example, to adjust the brightness of the display or illuminating the display with a backlight. The button 150 or buttons may be used for any number of purposes to input information by the user. Buttons may also be used by a user to enter pass codes or PINs.

The contactless electronic wallet 100 may also include a key chain 160 according to one embodiment of the invention. Other embodiments of the invention may include a contactless electronic wallet without a keychain. Other embodiments may also include a clip.

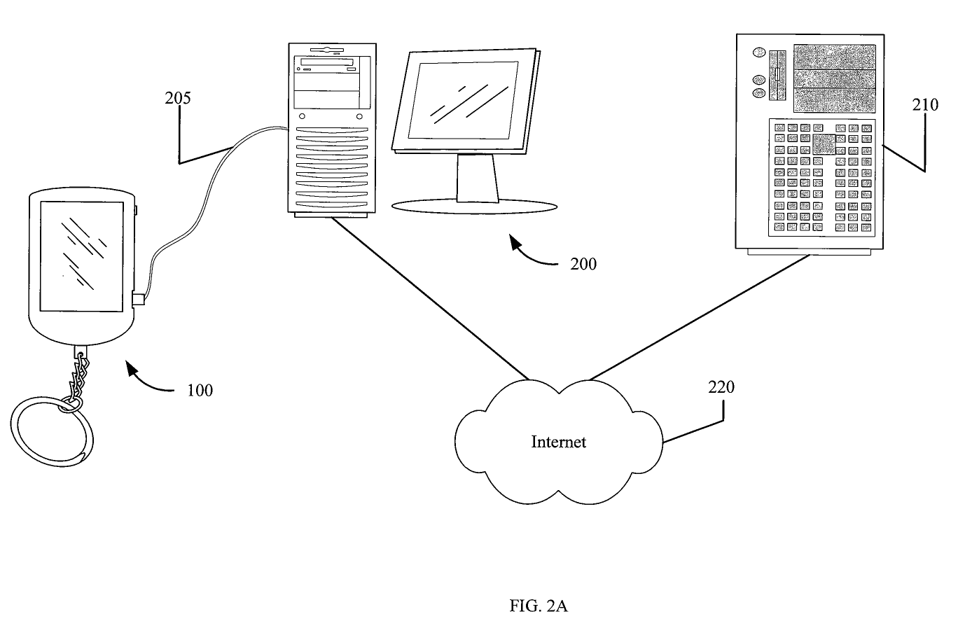

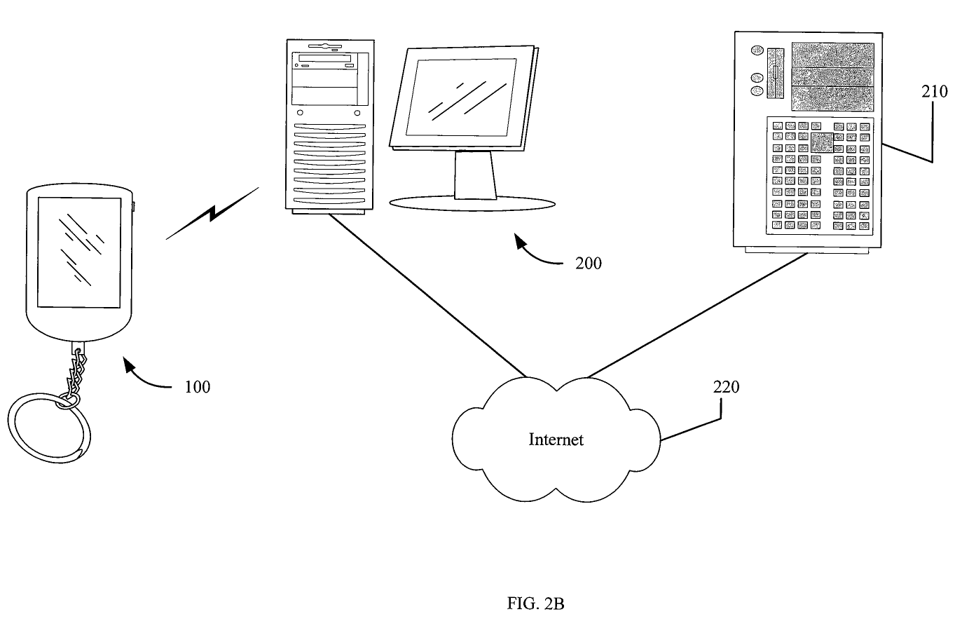

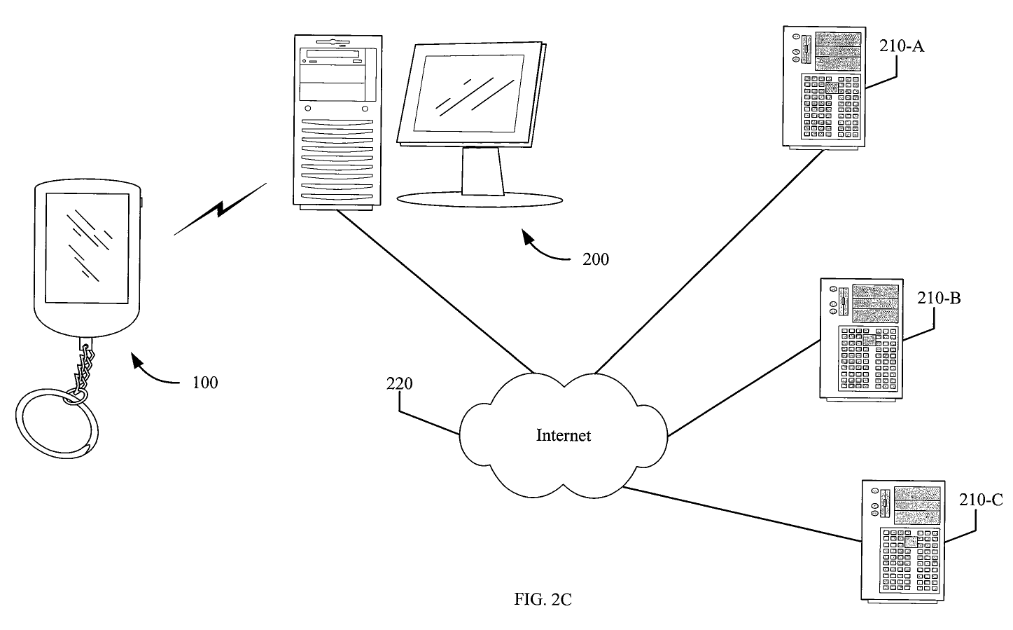

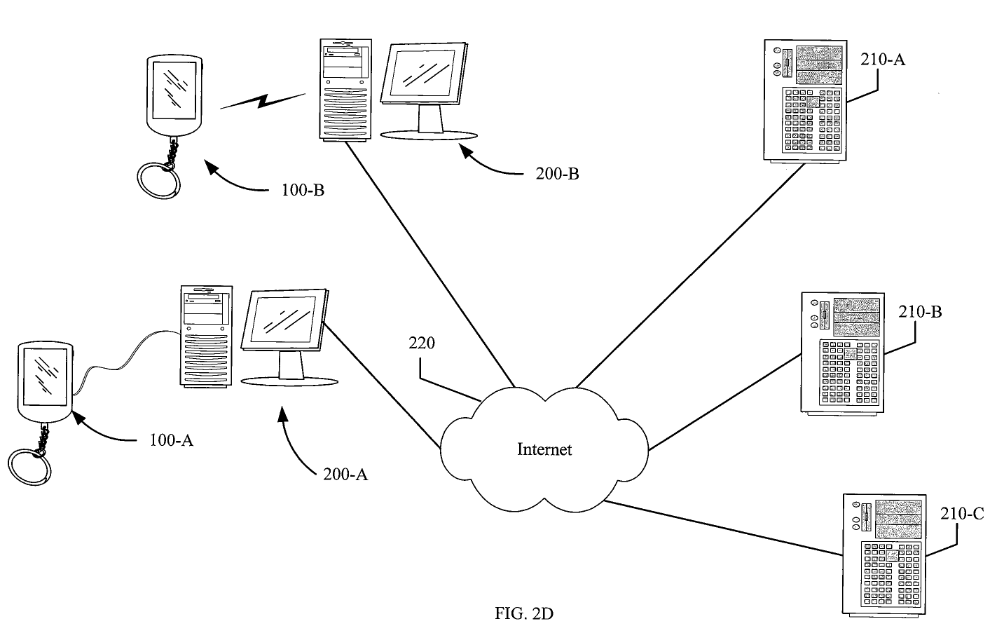

The contactless electronic wallet 100 may also include a communications interface 140 according to one embodiment of the invention. The communications interface 140 may be used to receive account information from a computer 200 as shown in FIG. 2A. A wire 205 is shown connecting the computer 200 to the contactless electronic wallet 100. The communications interface may be a mini USB interface, USB interface, serial interface, or firewire interface. Other interfaces may also be used.

The computer 210, as shown in FIG. 2A, is connected to the Internet 220, and a web browser may be used by the user to view various webpages and/or remote computer resources. The user may access a financial institutions webpage and log into an account. At this webpage, once logged in, the user may download account information to the computer 200. The account information may then be transferred to the contactless electronic wallet 100. Software on the computer may also be used to manage account information. The account information may include routing numbers, account numbers, account name, account balance, financial institution name, an icon, or other account information. Account information may be formatted according to a contactless payment standard. For example, the data may comply with the ISO 14443 standard. The downloaded account information may also comply with standards established by specific account providers such as, for example, MasterCard PayPass, American Express ExpressPay, Visa Contactless or JPMorgan Chase Blink. Account information can be transferred directly to the contactless electronic wallet. In other embodiments, the account information may be formatted by the computer 200 prior to transfer to the contactless electronic wallet 100. In yet another embodiment the data is formatted by the contactless electronic wallet 100 either prior to storage in memory or prior to radio frequency transmission.

Once a contactless electronic wallet 100 is connected to the computer 200 either wirelessly or with a wire, the computer may upload and/or delete account information from the contactless electronic wallet 100. Information from a plurality of bank accounts, credit card accounts, stored value accounts, debit card accounts, loyalty accounts, or ATM accounts may be stored on the contactless electronic wallet 100. Account numbers and the appropriate RFID information may be transmitted to the contactless electronic wallet 100 and stored in memory within the contactless electronic wallet 100.

As shown in FIG. 2B, the contactless electronic wallet 100 may communicate wirelessly with a computer 200. The contactless electronic wallet 100 may include wireless communication circuitry and/or an antenna for communication with the computer 200. The contactless electronic wallet 100 may communicate using wireless USB, Wi-Fi, Bluetooth, RFID, or other radio frequency-enabled device.

FIG. 2C shows a contactless electronic wallet 100 in wireless communication with a computer 200 that is coupled with two financial institution web servers 210-A, 210-B over the internet 220 according to one embodiment of the invention. FIG. 2D shows a system with three financial institution web servers 210-A, 210-B, 210-C in communication with two computers 200-A, 200-B over the internet according to one embodiment of the invention. The two computers 200-A, 200-B are in communication with two contactless electronic wallets 100-A, 100-B.

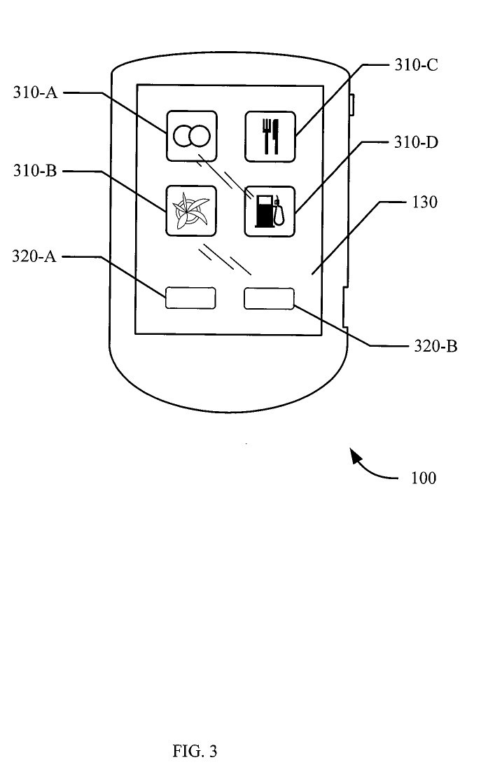

FIG. 3 shows a contactless electronic wallet 100 with a touch display displaying a number of different accounts 310 according to one embodiment of the invention. In this embodiment, the contactless electronic wallet 100 presents the user with four payment options 310-A, 310-B, 310-C, 310-D to the user. The payment options are presented as graphical icons on the display 130. Each icon may be representative of the company or account displayed. To make a financial transaction, the user simply selects an account by touching the appropriate icon associated with the payment option. Account information may then be transferred from memory to RFID circuitry within the contactless electronic wallet 100 for communication to a radio frequency-enabled communication device, such as, a radio frequency payment terminal. Once the payment has been received or after a small amount of time, the account information is transmitted back into memory so that account information may be communicated to a radio frequency-enabled communication device after selection by the user. Other icons 320-A, 320-B may be present on the touch display. These icons may be associated with various features of the contactless electronic wallet 100. For example, an icon 320 may cancel a selection; an icon 320 may be used to scroll through a listing of accounts, etc.

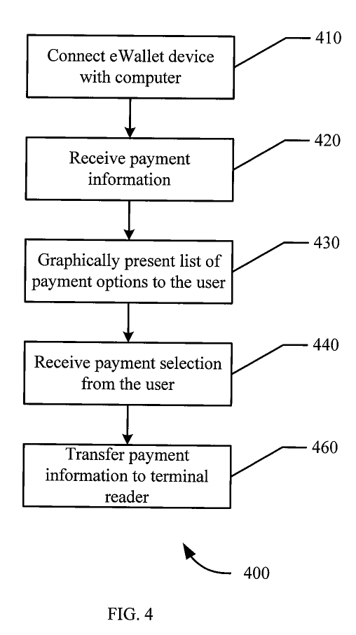

FIG. 4 shows a method 400 for using a contactless electronic wallet according to one embodiment of the invention. A contactless electronic wallet is connected to a computer 410 and account information is transmitted from the computer to the contactless electronic wallet through connection 420. Account information may include any of the following: user or accountholder identification, issuer or account provider identification, account number, data format indicator, validation information, expiration date, security application data such as checksums and/or dynamic CVV, or any combination thereof. The format of account data may vary depending on the type of account and/or radio frequency-enabled reader. A list of accounts associated with the account information is graphically arranged on the screen of the contactless electronic wallet 430. The graphical arrangement may include icons, lists, graphics, text, etc. The user selects an account for a transaction 440 and the account information is transferred to a radio frequency-enabled communication device as tender for the transaction.

In other embodiments of the invention a default account may be preset by the user. In such embodiments, the user may simple place the contactless electronic wallet near a radio frequency-enabled device and the default account information is communicated as tender for a transaction.

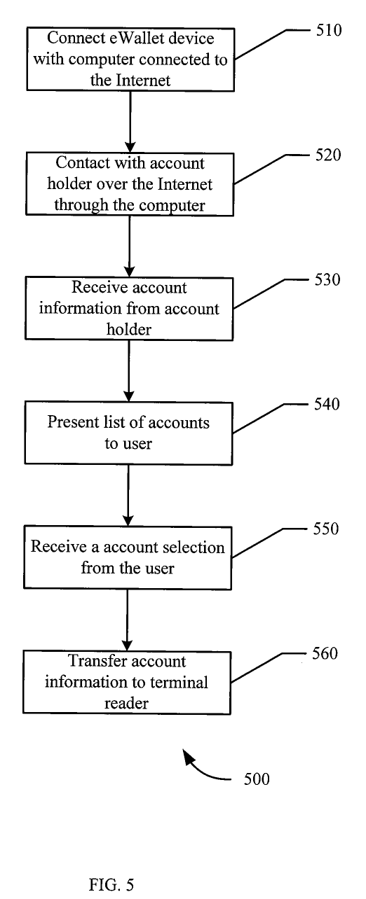

FIG. 5 shows another method 500 for using a contactless electronic wallet according to one embodiment of the invention. A contactless electronic wallet is connected to a computer that is connected to the Internet 510. The user of the computer may point a web browser to a webpage associated with a financial account, for example, a merchant webpage, and may purchase a stored value account and download contactless account information. The contactless electronic wallet may communicate with the account provider through the computer and Internet 520. Account information is downloaded from the account provider's webpage 530. The account information may be stored in memory within the contactless electronic wallet. When the user is ready to make a purchase at a merchant with radio frequency-enabled communications devices, such as a proximity coupling device, then the contactless electronic wallet presents a list of available accounts to the user 540. The user selects an account 550; whereupon, the contactless electronic wallet transfers account information to the radio frequency communication device 560.

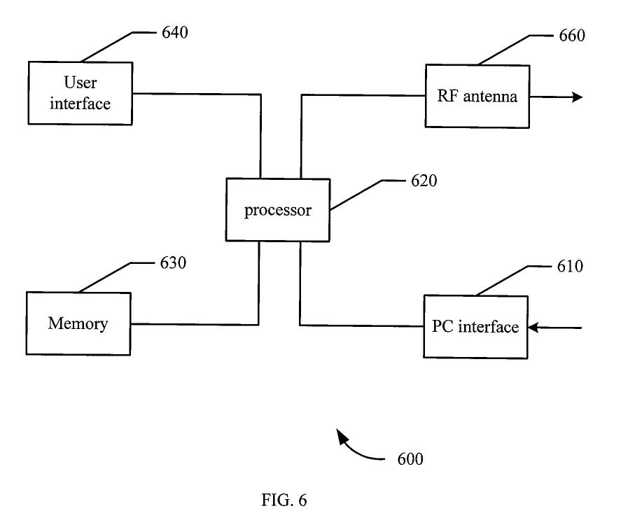

FIG. 6 shows a block diagram 600 of a contactless electronic wallet 100 according to one embodiment of the invention. A PC interface 610 communicates with a PC. As described, the PC interface 610 may communicate with the PC wirelessly or wired. The PC interface 610 receives account information from the PC. Information received from the PC is sent to the processor 620 and then stored in memory 630. In some embodiments, the processor may reformat the account information prior to storage. In other embodiments, account information may be sent directly to memory 630. The memory 630 may include any type of memory, for example, flash, EEPROM, PROM, EPROM, FeRAM, MRAM, PRAM, SONOS, RRAM, NRAM, DRAM, eDRAM, SRAM, 1T-SRAM, or Z-RAM.

The user interface 640 interacts with the user. The user interface 640 may include a display and/or buttons. The display may be a touch screen. Through the user interface, the user may request that the contactless electronic wallet display a list of accounts. The user may scroll through available accounts or be presented with a list or graphical grouping of accounts at the user interface. The user may choose an account from the list or grouping of accounts for use in a financial transaction. The processor will then pull the appropriate account information stored in memory and send the account information to the RF antenna for transmission to a radio frequency-enabled point of sale device. The processor may have to format the data to fit the needs of the radio frequency point of sale device. In some embodiments, the account information may be encrypted; the processor may then decrypt the account information prior to transmission to a point of sale device.

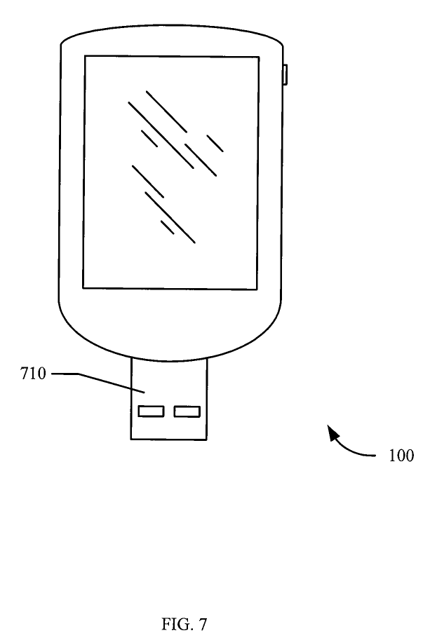

FIG. 7 shows a contactless electronic wallet 100 with a USB connector 710 according to one embodiment of the invention. The USB connector 710 may be retractable. A contactless electronic wallet 100 with the USB connector 710 allows the user to connect the contactless electronic wallet 100 directly to a computer through the USB connector 710.

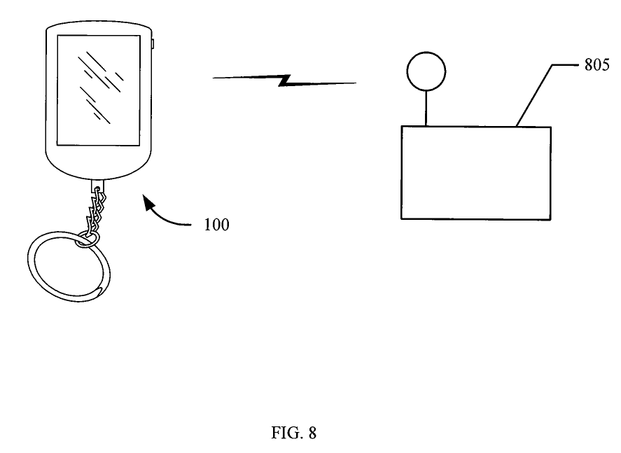

FIG. 8 shows a contactless electronic wallet 100 in communication with a point of sale device 805 enabled with a radio frequency communication device. As shown, the contactless electronic wallet 100 sends transaction information to the point of sale device 805 via radio frequency. In other embodiments, the contactless electronic wallet 100 may communicate with any number of communication protocols including Bluetooth, Wi-Fi, etc. The point of sale device may be configured and used as described in U.S. Pat. No. 7,086,584, which is hereby expressly incorporated herein by reference in its entirety for all purposes.

A number of variations and modifications of the disclosed embodiments can also be used. For example, the contactless electronic wallet may also contain loyalty card information, rental card information, activity card information, etc.

The contactless electronic wallet may be used to communicate tender or other information from a consumer to a merchant according to one embodiment of the invention. For example, a consumer at a grocery store may have access to various account and loyalty card information stored within the electronic wallet. When the user is prepared to tender payment, the contactless electronic wallet can present the user with a variety of icons representing loyalty cards, memberships, and/or accounts. For example, the user may first select a loyalty card account through the display and transmit loyalty card information to a point of sale device equipped with a radio frequency-enabled communication device. Following this step, the user may select a financial account, for example, a credit card account, and transmit credit card information to the point of sale device equipped with a radio frequency-enabled communication device.

Another embodiment of the invention includes account management software on the computer 200 according to one embodiment of the invention. The software may manage various accounts downloaded from account provider web pages, accounts that are manually entered into by the user, or an account sent via email. A listing of accounts and their properties may be presented by the account management software. For example, the account management software may present an account number, an expiration date, an account provider name, an icon, a description of account, an available balance, an available credit, etc. The account management software may then transfer accounts to the contactless electronic wallet. The account management software may also allow the user to select which accounts to transfer to the contactless electronic wallet. The user may choose, for example, to transfer information regarding a credit card account and loyalty card account, but not transfer information regarding a debit card account and a stored value account. The account management software may also include functionality to create rules whereby specific account types are automatically transferred to the contactless electronic wallet. The account management software may automatically synchronize account information when the contactless electronic device is connected to the computer, either wirelessly or wired. The account management software may synchronize account information only when the user requests synchronization. Multiple user profiles may be included in the software. The account management software may also enable the user to select a default account for the contactless electronic wallet.

Another embodiment of the invention includes a contactless electronic device that holds coupons for use at specific retailers or merchants. The user, instead of carrying paper coupons, may download coupons on the computer and transfer coupons to the contactless electronic wallet. The coupons may be redeemed by selecting the coupon on the contactless electronic device whereby the coupon is transferred to a point of sale device and the coupon is applied to a transaction.

Specific details are given in the above description to provide a thorough understanding of the embodiments of the invention. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

What is claimed is:

1. A contactless electronic wallet, comprising:
a communications interface adapted to receive financial account information related to at least one financial account from a computer, wherein the financial account information is received at the computer through the Internet;
a memory device adapted to electronically store financial account information for at least one financial account received through the communications interface from the computer;
a user interface adapted to communicate to a user an account list comprising at least one financial account associated with financial account information stored in the memory device, wherein the user selects a first financial account from the account list;
a RF antenna, wherein the RF antenna communicates account information associated with the first account to a radio frequency-enabled communication device; and
a processor coupled with the communications interface, the memory device, the user interface, and the RF antenna.

2. The contactless electronic wallet of claim 1, wherein the financial account information is received at the computer from one or more financial institution's web servers through the internet.

3. The contactless electronic wallet of claim 1, wherein the user interface comprises a touch screen.

4. The contactless electronic wallet of claim 1, wherein the user interface comprises a display and at least one button.

5. The contactless electronic wallet of claim 1, wherein the computer interface wirelessly communicates with the computer.

6. The contactless electronic wallet of claim 1, wherein the computer interface communicates with the computer using a communications standard selected from the group consisting of Bluetooth, radio frequency, Wi-Fi, USB, mini USB, and FireWire.

7. The contactless electronic wallet of claim 1, wherein financial account information comprises information selected from the group consisting of account number, account provider name, available credit, and available stored value.

8. The contactless electronic wallet of claim 1, further comprising a key chain.

9. The contactless electronic wallet of claim 1, further comprising a switch, wherein the switch is selected from the group consisting of a mechanical switch, a biometric switch, and a heat-sensitive switch.

10. The contactless electronic wallet of claim 1, wherein the financial account information is downloaded by the user from a webpage.

11. The contactless electronic wallet of claim 1, wherein each financial account in the account list is displayed on screen as a graphical icon.

12. The contactless electronic wallet of claim 1, further comprising a USB connector.

13. A method for managing account information at a contactless electronic wallet, the method comprising:
receiving financial account information related to at least one financial account from a computer, wherein the financial account information is received at the computer through the Internet;
storing the financial account information received from the computer through the communications interface in a memory device;
communicating to a user a financial account list comprising at least one financial account associated with the financial account information stored in the memory device;
receiving a first selection from the user, wherein the first selection comprises a first financial account selected by the user from the account list; and
communicating the financial account information associated with the first account to a radio frequency-enabled communication device.

14. The method for managing account information at a contactless electronic wallet according to claim 13, wherein the communicating comprises presenting an icon representing an account on a display.

15. An account management system for managing accounts on a contactless electronic wallet, comprising:
a network interface connected to the Internet and in communication with an account provider;
a memory device adapted to store account information received through the network interface;
a contactless electronic wallet interface, wherein the contactless electronic wallet interface can be connected to a contactless electronic wallet; and
a processor comprising:
instructions to receive a plurality of account information for a plurality of accounts from a plurality of account providers over the internet;
instructions to store the plurality of account information in the memory device; and
instructions to transmit at least one of the plurality of account information to a contactless electronic wallet through the contactless electronic wallet interface.

16. The account management system of claim 15, wherein the processor further comprises instructions to automatically transmit account information when a contactless electronic wallet is connected to the account management system.

17. The account management system of claim 15, wherein the processor further comprises instructions to reformat account information prior to transmitting the account information to the contactless electronic wallet.

18. The account management system of claim 15, wherein the contactless electronic wallet interface communicates with the contactless electronic wallet using a communications standard selected from the group consisting of Bluetooth, radio frequency, Wi-Fi, USB, mini USB, and FireWire.

19. The account management system of claim 15, wherein account information is downloaded by the user from a webpage.

20. The account management system of claim 15, wherein account information comprises information selected from the group consisting of account number, account provider name, available credit, and available stored value.
